(19) United States
(12) Patent Application Publication
(10) Pub. No.: US 2025/0189336 A1
(43) Pub. Date: Jun. 12, 2025

(54) METHOD AND SYSTEM FOR PROVIDING NAVIGATION SERVICE

(71) Applicant: HYUNDAI AUTOEVER CORP., Seoul (KR)

(72) Inventors: Hee Eun LEE, Seoul (KR); Won Heung JO, Seoul (KR); Ji Young HAN, Seoul (KR); Esther CHOI, Seoul (KR); Joo Ho CHAE, Seoul (KR); Il Kyun KIM, Seoul (KR); Min Jeong KIM, Seoul (KR); Yeon Kyung CHUNG, Seoul (KR); Hwa Hyeon HONG, Seoul (KR); Rak Jun SUNG, Seoul (KR)

(21) Appl. No.: 18/969,850

(22) Filed: Dec. 5, 2024

(30) Foreign Application Priority Data
Dec. 7, 2023 (KR) 10-2023-0176412

(51) Int. Cl. G01C 21/36

(52) U.S. Cl. CPC G01C 21/367; G01C 21/3685

(57) ABSTRACT

Methods for providing a navigation service are proposed. According to an embodiment, a method comprises displaying a navigation screen related to a first camera angle, determining whether an event related to an angle change has occurred based on a measured location, changing a camera angle of the navigation screen from the first camera angle to a second camera angle based on determination that the event related to the angle change has occurred, and displaying an information related to the event.

### CROSS-REFERENCE TO RELATED APPLICATION

This application claims priority from Korean Patent Application No. 10-2023-0176412 filed on Dec. 7, 2023 in the Korean Intellectual Property Office, and all the benefits accruing therefrom under 35 U.S.C. 119, the contents of which in its entirety are herein in company by reference.

### BACKGROUND

### Field

The present disclosure relates to a method and system for providing a navigation service. More specifically, the present disclosure relates to a method and system for providing a navigation service with improved visibility and convenience.

### Description of Related Art

A navigation device is mounted on a vehicle, etc., and guides the vehicle along a travel route to a destination. The navigation device displays the travel route using a line having a predetermined color.

The navigation device also determines the color of the line indicating the travel route based on a congestion level of each of roads. For example, when the congestion level of the road exceeds a threshold, the travel route is displayed using a red line.

However, a conventional navigation device presets a camera angle, and outputs a map image at the set camera angle. When a user wants to view a map image as viewed in a specific angle, the angle of the map image should be changed via an input such as an angle rotation input.

Furthermore, the conventional navigation device provides only map information to the user. When the user wants to acquire information about a specific location, he/she should manipulate a navigation screen or perform a separate search.

Accordingly, a scheme is required that automatically changes the camera angle and easily provides additional location-related information to the user.

### SUMMARY

A technical purpose to be achieved in accordance with some embodiments of the present disclosure is to provide a navigation service providing method and system that automatically changes a camera angle of a navigation screen to improve visibility of a map image.

Another technical purpose to be achieved in accordance with some embodiments of the present disclosure is to provide a navigation service providing method and system which intuitively and conveniently provides additional information related to a current location to the user based on an event.

Still another technical purpose to be achieved in accordance with some embodiments is to provide a navigation service providing method and system that enables faster and more convenient parking.

Still yet another technical purpose to be achieved in accordance with some embodiments is to provide a method and system for providing a navigation service that allows a user to conveniently and quickly move to a destination by displaying a travel route from an elevator to the destination.

The technical purposes of the present disclosure are not limited to the technical purposes as mentioned above, and other technical purposes as not mentioned may be clearly understood by those skilled in the art from descriptions as set forth below.

According to an aspect of the present disclosure, there is provided a method for providing a navigation service, the method being performed by a computing system. The method may comprise displaying a navigation screen related to a first camera angle, determining whether an event related to angle change has occurred based on a measured location, changing a camera angle of the navigation screen from the first camera angle to a second camera angle, based on determination that the event related to the angle change has occurred and displaying information related to the event.

In some embodiments, the determining of whether the event has occurred may include determining that the event has occurred when the measured location is included in a location range related to a parking lot, wherein the displaying of the information related to the event may include displaying information related to the parking lot.

In some embodiments, the information related to the parking lot may include a parking lot drawing, wherein at the second camera angle, the parking lot drawing may be displayed in a plan view on the navigation screen.

In some embodiments, the information related to the parking lot may include a parking lot drawing, wherein in the parking lot drawing, an available parking space is visualized using a first graphic element.

In some embodiments, in the parking lot drawing, a parking space for a driver requiring social consideration may be visualized using a second graphic element.

In some embodiments, the method may further comprise, after the displaying of the information related to the event, changing the camera angle of the navigation screen to the first camera angle after a predetermined time duration has elapsed.

In some embodiments, the determining of whether the event has occurred may include determining that the event has occurred when the measured location is included in a location range related to an elevator, wherein the changing of the first camera angle to the second camera angle includes zooming out the first camera angle to change the camera angle of the navigation screen to the second camera angle.

In some embodiments, the displaying of the information related to the event may include displaying at least one of a floor where a user is located, and information on the floor.

In some embodiments, the displaying of the information related to the event may include identifying a floor where a destination is located and displaying information including at least one of the identified floor and a travel route to the destination.

In some embodiments, the determining of whether the event has occurred may include determining that the event has occurred when the measured location is included in a location range related to an access road, wherein the displaying of the information related to the event may include displaying a guidance line related to the access road.

According to another aspect of the present disclosure, there is provided a method for providing a navigation service, the method being performed by a computing system. The method may comprise determining whether a measured location is included in a location range related to a parking lot, acquiring parking lot information including an available parking space, upon determination that the measured location is included in the location range related to the parking lot and displaying a navigation screen including a number of currently available parking spaces in each parking zone, and a moving direction to each parking zone, based on the acquired parking lot information, wherein one vehicle corresponds to one parking space.

In some embodiments, the displaying of the navigation screen may include displaying of the navigation screen in which a first graphic element indicating the moving direction to each parking zone and a second graphic element indicating the number of currently available parking spaces are displayed in a related manner to each other.

In some embodiments, the displaying of the navigation screen may include determining a recommended parking zone based on the acquired parking lot information and displaying the navigation screen in which a travel route to the recommended parking zone is visualized using a third graphic element.

In some embodiments, the determining of the recommended parking zone may include determining the recommended parking zone based on the number of currently available parking spaces in each parking zone included in the acquired parking lot information and the measured location.

According to another aspect of the present disclosure, there is provided a method for providing a navigation service, the method being performed by a computing system. The method may comprise calculating a remaining time until an appointment time, determining an animation to be outputted, based on at least one of the calculated remaining time and a distance to a destination and displaying a navigation screen including the determined animation.

In some embodiments, the determining of the animation to be outputted may include calculating an urging index based on at least one of the calculated remaining time and the distance to the destination, when the calculated urging index is included in a first range, determining a first animation changing at a first speed as the animation to be outputted and when the calculated urging index is included in a second range, determining a second animation changing at a second speed as the animation to be outputted.

In some embodiments, the displaying of the navigation screen may include generating a travel route from a measured location to the destination upon detection that a vehicle has been parked and displaying the navigation screen in which the generated travel route is displayed, wherein the animation to be outputted is played in relation with the travel route.

In some embodiments, the computing system may include a mobile terminal, wherein upon detection that the vehicle has been parked, the mobile terminal may display the navigation screen.

In some embodiments, the computing system may include a navigation device, wherein when the mobile terminal receives a message related to a vehicle engine stop from the navigation device, the mobile terminal may determine that the vehicle has been parked and outputs the navigation screen.

In some embodiments, the navigation screen may be capable of simulation, wherein the method further may comprise receiving a user input of swiping on the screen in a first direction or a second direction and based on the received user input, playing the travel route at a predetermined speed or rewinding the travel route at the predetermined speed.

### BRIEF DESCRIPTION OF DRAWINGS

The above and other aspects and features of the present disclosure will become more apparent by describing in detail illustrative embodiments thereof with reference to the attached drawings, in which:

FIG. 1 is a diagram illustrating a configuration of a navigation system according to an embodiment of the present disclosure;

FIG. 2 is a flowchart for illustrating a method for providing a navigation service according to an embodiment of the present disclosure;

FIG. 3 is a flowchart for illustrating details of operation in S240 of FIG. 2 performed when an event is a first event related to a parking lot according to an embodiment of the present disclosure;

FIG. 4 is a diagram illustrating a parking lot drawing printed in a plan view according to an embodiment of the present disclosure;

FIG. 5 is a diagram illustrating a navigation screen displaying a travel route to a recommended parking zone according to an embodiment of the present disclosure;

FIG. 6 is a flowchart for illustrating details of operation in S240 of FIG. 2 performed when an event is a second event related to an elevator according to an embodiment of the present disclosure;

FIG. 7 is a diagram illustrating a navigation screen including a travel route from an elevator to a destination located on a 7th floor according to an embodiment of the present disclosure;

FIG. 8 is a flowchart for illustrating details of operation in S240 of FIG. 2 performed when an event is a third event related to an access road according to an embodiment of the present disclosure;

FIG. 9 is a diagram illustrating a navigation screen including a guidance line to an access road according to an embodiment of the present disclosure.

FIG. 10 is a flowchart illustrating a method for providing a navigation service according to an embodiment of the present disclosure;

FIG. 11 is a diagram illustrating a navigation screen including a first animation according to an embodiment of the present disclosure.

FIG. 12 is a diagram illustrating a navigation screen including a second animation according to an embodiment of the present disclosure;

FIG. 13 is a signal processing diagram for illustrating a method in which a navigation device displays a navigation screen in association with a mobile terminal according to still an embodiment of the present disclosure; and

FIG. 14 is a hardware configuration diagram of a computing system according to some embodiments of the present disclosure.

### DETAILED DESCRIPTIONS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, embodiments of the present disclosure will be described with reference to the attached drawings.

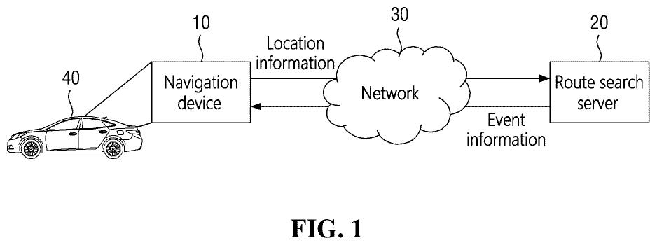

FIG. 1 is a diagram illustrating a configuration of a navigation system according to an embodiment of the present disclosure.

Referring to FIG. 1, the navigation system may include a navigation device 10 and a route search server 20. The navigation device 10 may be mounted on a vehicle 40. In some embodiments, the navigation device 10 may be included in a mobile terminal such as a smartphone.

The navigation device 10 may display a navigation screen including a map image. According to an embodiment, the navigation device 10 may communicate with a route search server 20 via a network 30. In this regard, the network 30 may be configured to include a short-range wireless communication network, a mobile communication network, a wired communication network, etc.

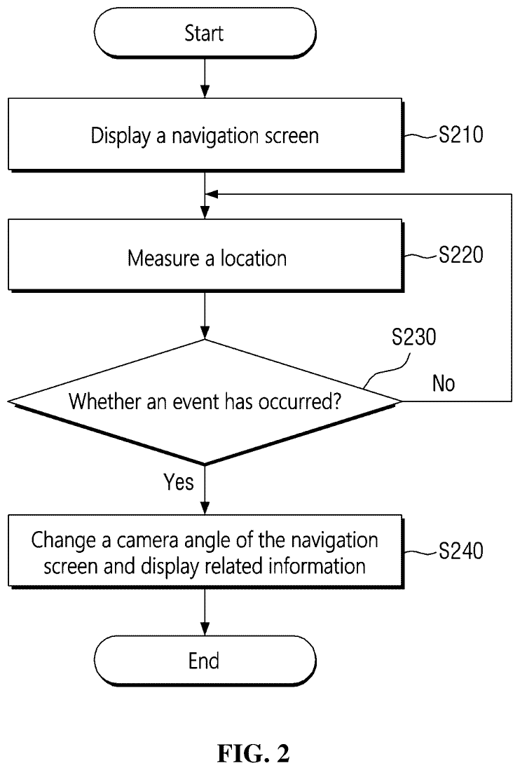

According to an embodiment, the navigation device 10 includes a GNSS (Global Navigation Satellite System) receiver, and may measure a current location using the GNSS receiver. Furthermore, the navigation device 10 may automatically change a camera angle of the navigation screen being output when the current location is an event-related location. In some embodiments, the navigation device 10 may display additional information when the current location is an event-related location. In this regard, the additional information may include information related to the current location, such as parking-related information, floor-related information, and guidance line-related information. Various examples of changing the camera angle or displaying of the additional information based on an event will be described later with reference to FIG. 2 to FIG. 12.

The route search server 20 includes map data, and may also calculate the congestion level of each road in real time. The route search server 20 may receive the current location and a moving speed from a plurality of navigation devices 10, and may calculate the congestion level of each road based on the current location and the moving speed of each navigation device 10.

The route search server 20 may receive a route search request including the current location and the destination location from the navigation device 10. In this case, the route search server 20 may search for one or more routes based on the congestion level of each road, the current location of the navigation device 10, the destination location, etc., and transmit the searched one or more routes to the navigation device 10. In this regard, the one or more routes may include at least one of the shortest route, the smallest time route, etc. The route search server 20 may transmit one or more event information to the navigation device 10. In this regard, the event information may include a changed camera angle, an event location range, additional information, etc. For example, the first event information may include a changed camera angle, additional information related to parking, a location range related to a parking lot, etc. In an example, the second event information may include a changed camera angle, information about each floor, a location range related to an elevator, etc. In still an example, the third event information may include a changed camera angle, a location range related to an access road, etc.

According to an embodiment, the route search server 20 may transmit the map data to the navigation device 10. In this regard, the map data may include road-related map data, pedestrian-related map data, indoor map data, etc. Each map data may include at least one of a two-dimensional map image and a three-dimensional map.

According to some embodiments, the route search server 20 may transmit the map data based on a digital twin to the navigation device 10. In this regard, the digital twin is a virtual implementation of an actual road, building, sidewalk, etc., and the data related to the digital twin may be stored in the route search server 20. For example, a digital-based virtual model in which an actual road, sidewalk, building, inside of the building, and each of facilities (overpass, parking barrier, crosswalk, sign, shelf, etc.) is virtually implemented may be stored in the route search server 20 and/or the navigation device 10. Each virtual road, each crosswalk, and each facility included in the digital twin may include location information. In this regard, the location information may include the GNSS coordinate range or GNSS representative coordinate where the actual road, the actual crosswalk, the actual sidewalk, and the actual facility are located.

When the route search server 20 transmits the map data based on the digital twin to the navigation device 10, the navigation device 10 outputs a map image based on the digital twin, and may perform navigation using the map image based on the digital twin.

According to this embodiment, the camera angle may be changed based on occurrence of an event, and the navigation screen at the changed camera angle may be displayed, thereby improving the visibility of the map image. Furthermore, since the additional information related to the event is automatically output, the user may conveniently acquire the information related to the current location. Furthermore, according to this embodiment, the visibility may be further improved by displaying of the map image based on the digital twin to the navigation device 10.

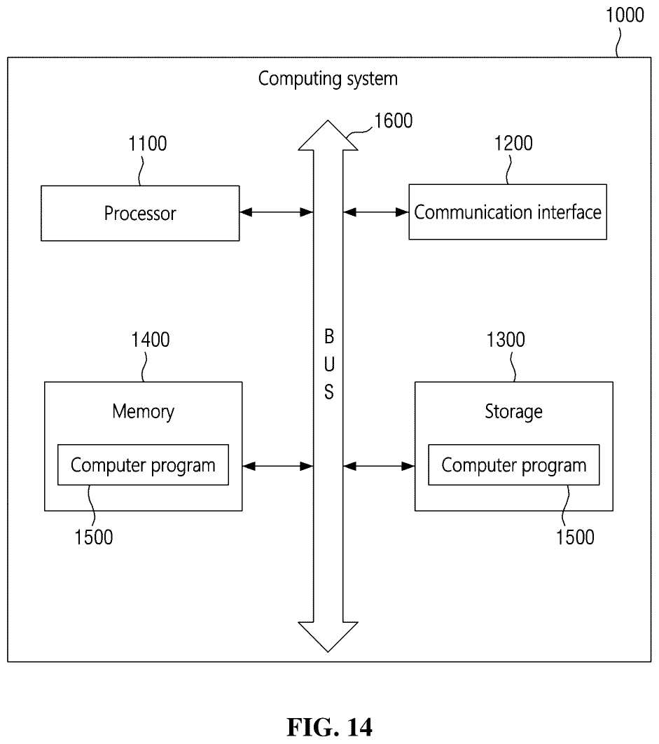

FIG. 2 is a flowchart for illustrating a method for providing a navigation service according to an embodiment of the present disclosure. The method illustrated in FIG. 2 is only an embodiment for achieving the purpose of the present disclosure, and it is obvious that some operations may be added or deleted as needed. Furthermore, the method illustrated in FIG. 2 may be performed by at least one processor (e.g., a processor illustrated in FIG. 14) included in a computing system. In this regard, the computing system may include at least one of the navigation device, the mobile terminal, and the route search server. For convenience of description, FIG. 2 will be described under assumption that the method is performed by the navigation device illustrated in FIG. 1.

The navigation device may display a navigation screen including a map image in S210. For example, the navigation device may measure a current location, and may display a navigation screen including the map image within a predetermined range based on the measured current location. The navigation screen may include a line indicating a travel route to a destination.

Next, the navigation device may measure the current location periodically or in real time in S220.

Next, the navigation device may determine whether an event related to a camera angle change has occurred based on the measured location in S230. For example, the navigation device may determine whether the currently measured location is included in the event location range related to the camera angle change.

Next, when the navigation device determines that the event related to the camera angle change has occurred, the navigation device may determine a target camera angle based on the event. Next, the navigation device may change a current navigation screen to a navigation screen at the determined target camera angle, and may display information related to the event in S240. The navigation device may determine whether the event related to the camera angle change has occurred based on the location range included in the event information received from the route search server and the currently measured location. In this regard, the changed camera angle may be related to a predetermined angle, direction, zoom ratio, etc. For example, the camera angle may be a camera angle related to a plan view, a camera angle related to a perspective view, a camera angle related to a first-person/third-person view, a camera angle related to a zoom out, a camera angle related to a zoom in, etc.

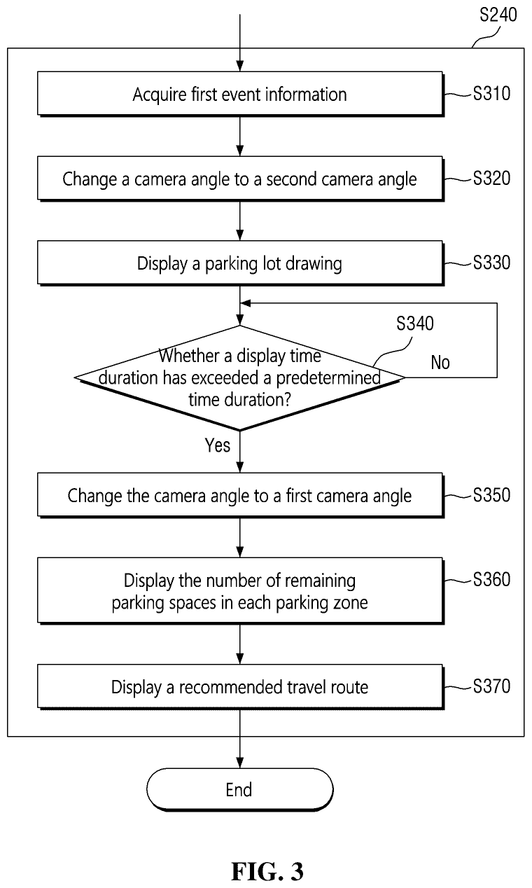

Furthermore, the event-related information may be related to additional information at the current location. For example, the event-related information may include parking lot information, the number of floors of the current location, information on each floor, a walking travel route to the destination, the number of vehicles that may be parked on each floor, etc. With reference to FIGS. 3 to 12, various examples of changing the camera angle or displaying of the event-related information based on an event will be described.

When a predetermined time has elapsed, the navigation device may change the camera angle of the navigation screen to a first camera angle as a previous camera angle.

The method according to FIG. 2 shows an example of changing the camera angle, and each of operations included in the method according to FIG. 2 may be repeatedly performed until the navigation service is terminated.

FIG. 3 is a flowchart for illustrating details of operation in S240 of FIG. 2 performed when the event is a first event related to a parking lot according to an embodiment of the present disclosure. Each of operations illustrated in FIG. 3 may be executed when a type of the first event is a parking lot-related event.

Referring to FIG. 3, the navigation device may acquire the first event information related to the current location in S310. For example, when the first event has been detected, the navigation device may receive and acquire first event information from the route search server. In an example, when the navigation device acquires travel route information from the route search server, the navigation device may receive the first event information together with the travel route information and pre-store the first event information in a storage means (e.g., storage, memory, etc.), and then extract the first event information from the storage means when the first event has been detected. In this regard, the first event information may include parking lot information and a location range related to the parking lot. Furthermore, the parking lot information may include a parking lot drawing, a plurality of partitioned parking zones, the number of vehicles that may be parked in each zone, a location of an available parking space in which the vehicle may be currently parked, and a location of a parking space that requires social consideration. In this regard, the location of the parking space that require social consideration may include disabled parking spaces, women-only parking spaces, etc.

Next, the navigation device may change the camera angle of the navigation screen from the first camera angle to a second camera angle in S320. In this regard, the first camera angle may be a camera angle set a default value, and the second camera angle may be a camera angle at which the camera looks down at the image at a predetermined angle. For example, the navigation device may change the camera angle so that the map image is displayed in a form of the plan view when the first event related to the parking lot has been detected.

Next, the navigation device extracts the parking lot drawing from the first event information, and may display the extracted parking lot drawing in S330. The parking lot drawing is an image showing an entire parking space located on the floor of interest, and may be displayed in the form of the plan view.

Next, the navigation device may acquire the location of available parking spaces and the location of parking spaces requiring social consideration from the first event information, and may visualize the location of available parking spaces on the parking lot drawing using a first graphic element, and may visualize the parking spaces requiring social consideration using a second graphic element. In this regard, the first graphic element may include a first color/first pattern/first shape, and the second graphic element may include a second color/second pattern/second shape. In some embodiments, the navigation device may receive the parking lot drawing including the available parking space visualized by the first graphic element and the space requiring social consideration visualized by the second graphic element from the route search server.

Next, the navigation device may determine whether a time duration for which the parking lot drawing is displayed has exceeded a predetermined time duration in S340. When the display time duration thereof has exceeded the predetermined time duration, the navigation device may change the camera angle of the navigation screen to the first camera angle, such that the current camera angle may return to one before it was changed in S350.

Next, the navigation device extracts the number of remaining parking spaces (i.e., the number of currently available parking spaces) on each parking zone from the first event information, and may display the navigation screen displaying a direction toward each parking zone and the number of remaining parking spaces on each parking zone based on the current location in S360. The direction toward the parking zone and the number of remaining parking spaces on the parking zone may be displayed in a manner so as to be related to each other.

Next, the navigation device may determine a recommended parking zone from among a plurality of parking zones based on the number and location of remaining parking spaces on each parking zone. Next, the navigation device may display the navigation screen displaying a travel route to the recommended parking zone as a recommended travel route in S370. The navigation device may visualize the recommended travel route on the navigation screen using a separate graphic element. In this regard, the separate graphic element may include a specific color, shape, icon, pattern, etc.

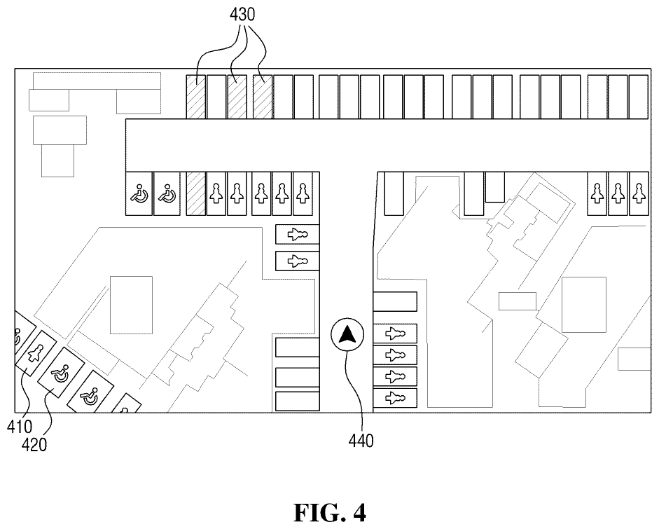

FIG. 4 is a diagram showing an example of a parking lot drawing output in a plan view according to an embodiment of the present disclosure.

A parking lot drawing in a plan view form as in FIG. 4 may be displayed through a navigation screen having the second camera angle to which the first camera angle has changed. As illustrated in FIG. 4, in the parking lot drawing, parking space locations 410 and 420 that require social consideration may be visualized using a separate graphic element. For example, a women-only parking space 410 may be visualized and displayed using a first graphic element, and a disabled-only parking space 420 may be visualized and displayed using a second graphic element.

Furthermore, a currently available parking space 430 may be visualized and displayed using a third graphic element. A space where the vehicle has been already located, that is, a non-available space may be visualized and displayed using a fourth graphic element. In an example, although not shown in the drawing, an electric vehicle-only space may be visualized and displayed using a fifth graphic element, and a small vehicle-only parking space may be visualized and displayed using a sixth graphic element. In this regard, the graphic element may include at least one of color, text, shape, icon, pattern, etc.

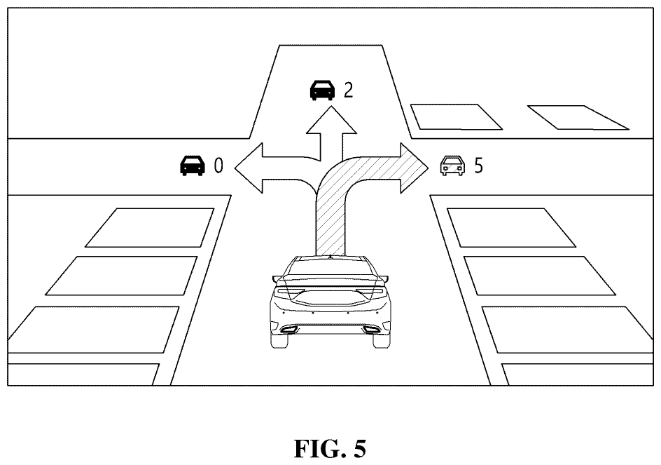

FIG. 5 is a diagram for illustrating a navigation screen displaying a travel route to a recommended parking zone according to an embodiment of the present disclosure.

Referring to FIG. 5, a navigation screen including the number of vehicles that can be currently parked in each parking zone (i.e., the number of remaining parking spaces in each parking zone) may be displayed. That is, the navigation device may display the number of vehicles that can be currently parked in each parking zone based on the number of remaining spaces in each parking zone included in the first event information. Furthermore, the navigation device may display a navigation screen including a travel route to each parking zone based on a location of each parking zone included in the first event information and the current location. In FIG. 5, the travel route to each parking zone is illustrated as a line including an arrow based on the current location. Furthermore, in FIG. 5, an example is illustrated in which a left parking zone has the number of currently available spaces of ‘0’, a front parking zone has the number of currently available spaces of ‘2’, and a right parking zone has the number of currently available spaces of ‘5’.

According to an embodiment, the recommended parking zone may be determined based on at least one of the location of each parking zone and the number of currently available spaces in each parking zone. For example, the navigation device may apply a first weight to a distance between the current location and the location of each parking zone, and may apply a second weight to the number of remaining spaces in each parking zone (i.e., the number of currently available spaces in each parking zone), and then sum the weighted distance and number of remaining spaces to calculate a recommendation index of each parking zone. The navigation device may determine the parking zone with the highest recommended index as the recommended parking zone. The navigation device may determine the travel route to the determined recommended parking zone as the recommended travel route, and then visualize the determined recommended travel route as a separate graphic element and display the visualized determined recommended travel route on the navigation screen. In FIG. 5, an example in which the route expressed in a hatching manner is the recommended travel route is shown.

According to this embodiment, when a user has entered the parking lot, a parking lot map in a form of a plan view may be displayed, so that the user may conveniently identify available parking spaces, parking spaces requiring social consideration, etc. through the parking lot map output in the form of the plan view. In addition, the parking may be performed quickly and conveniently through the travel route to the recommended parking zone.

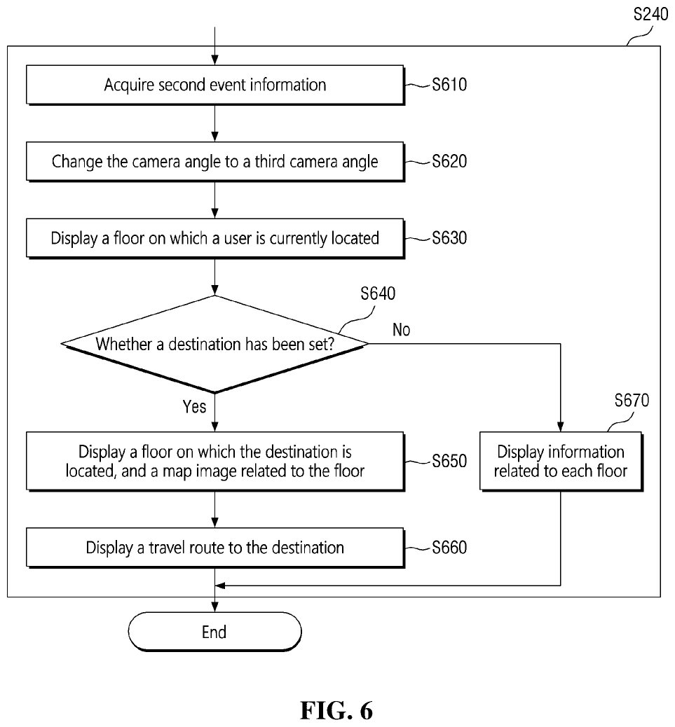

FIG. 6 is a flowchart for illustrating details of operation in S240 of FIG. 2 performed when an event is a second event related to an elevator according to an embodiment of the present disclosure. Each of operations shown in FIG. 6 may be executed when a type of the second event is an elevator-related event.

Referring to FIG. 6, the navigation device may acquire second event information related to the current location in S610. For example, when the second event has been detected, the navigation device may receive and acquire the second event information from the route search server. In an example, when the navigation device acquires travel route information from the route search server, the navigation device may receive the second event information together therewith and store the second event information in a storage means (e.g., storage, memory, etc.). Then, when the second event occurs, the navigation device may extract the second event information from the storage means. In this regard, the second event information may include floor information, indoor map images, destination location information, a location range, etc.

Next, the navigation device may change the camera angle of the navigation screen from the first camera angle to a third camera angle in S620. In this regard, the third camera angle may refer to the first camera angle zoomed out by a predetermined magnification. For example, the navigation device may change the camera angle so that the map image zoomed out by a predetermined magnification is displayed when the second event related to the elevator has been detected.

Next, the navigation device may identify a floor on which the user is located, and may display an image of the identified floor in S630. For example, when the current location is the 3rd floor, the navigation device may display floor information indicating that the current location is the 3rd floor.

Next, the navigation device may determine whether a destination has been set in S640. In this regard, the destination may be a location located on a specific floor.

When the navigation device determines that the destination has been set, the navigation device may display the floor on which the destination is located and a map image related to the floor in S650. For example, the navigation device may display a map image including a plan view of the floor on which the destination is located.

Next, the navigation device may display a travel route to the destination on the navigation screen in S660. For example, the navigation device may display a travel route from the elevator or the current location to the destination on the navigation screen using a specific graphic element.

In an example, when the navigation device determines that the destination is not set, the navigation device may display information related to each floor in S670. For example, the navigation device may display information about each floor, including the status of stores and offices on each floor.

In an example, when the elevator is a vehicle elevator, the navigation device may display floor-specific parking information including the number of vehicles (the number of available parking spaces) that can be currently parked on each floor. In this case, the navigation device may receive the second event information including the number of vehicles that can be currently parked on each floor from the route search server, and may display the floor-specific parking information based on the number of vehicles that can be currently parked on each floor included in the second event information.

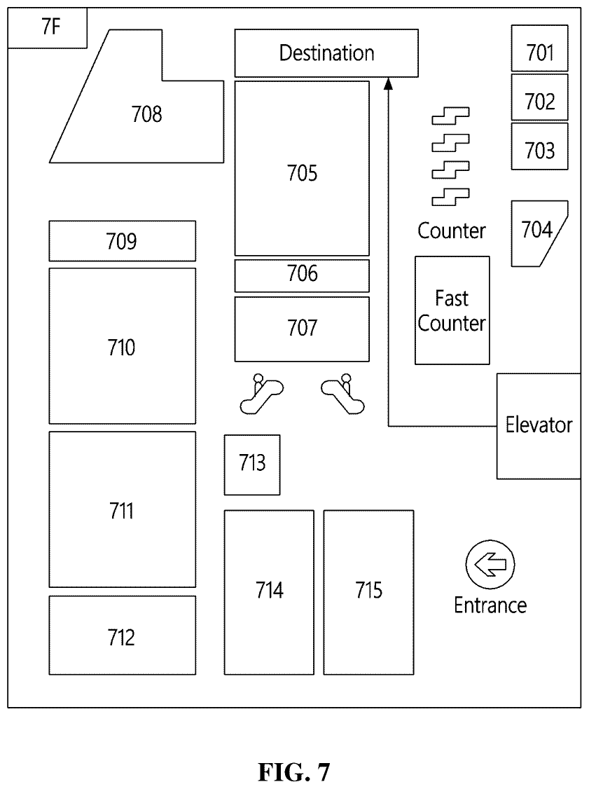

FIG. 7 is a diagram for illustrating a navigation screen including a travel route from an elevator to a destination located at a 7th floor according to an embodiment of the present disclosure.

As illustrated in FIG. 7, a navigation screen including a travel route from an elevator to a destination may be displayed. Furthermore, the navigation screen may display a map related to the 7th floor. The map related to the 7th floor includes an area and location of each store/office.

According to this embodiment, when the user has entered an area related to an elevator, a navigation screen which has been zoomed-out and including a floor on which the use is located may be displayed, so that the floor on which the user is located may be intuitively provided. Furthermore, using a navigation screen including a travel route from the current location (i.e., the elevator) to the destination, the user may conveniently and quickly move from the elevator to the destination.

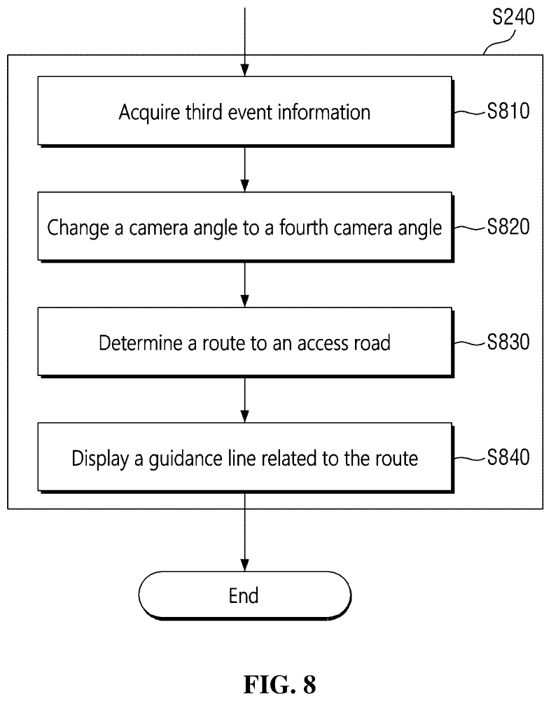

FIG. 8 is a flowchart for illustrating details of operation in S240 of FIG. 2 performed when an event is a third event related to an access road according to an embodiment of the present disclosure. Each of operations illustrated in FIG. 8 may be executed when a type of the third event is an access road-related event.

Referring to FIG. 8, the navigation device may acquire third event information related to the current location in S810. The third event information may include a location range related to the access road.

Next, the navigation device may change the camera angle of the navigation screen from the first camera angle to a fourth camera angle in S820. In this regard, the fourth camera angle may refer to the first camera angle rotated by a predetermined angle and direction. For example, the navigation device may change the camera angle by a predetermined angle and direction when the third event related to the access road has been detected.

Next, the navigation device may determine a travel route from the current location to the access road in S830. Next, the navigation device may visualize the determined travel route using a specific graphic element to generate a guidance line, and may display a navigation screen including the guidance line in S840.

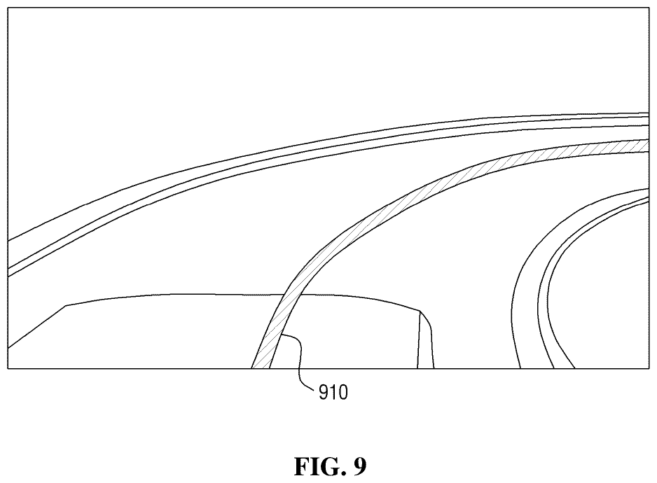

FIG. 9 is a diagram for illustrating a navigation screen including the guidance line to the access road according to an embodiment of the present disclosure.

As illustrated in FIG. 9, a guidance line 910 that guides movement to the access road may be visualized on the navigation screen using a specific graphic element. In this regard, the access road may be an access road to a parking lot.

According to this embodiment, a travel route to the access road such as a building access road, a parking lot access road, etc. may be intuitively provided to the user through the guidance line.

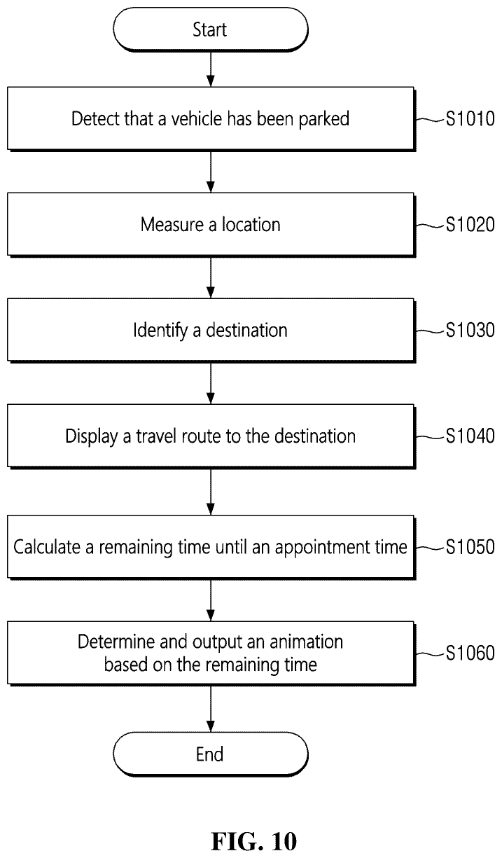

FIG. 10 is a flowchart for illustrating a method for providing a navigation service according to an embodiment of the present disclosure. The method illustrated in FIG. 10 is only an embodiment for achieving the purpose of the present disclosure, and some operations may be added or deleted as needed. Furthermore, the method illustrated in FIG. 10 may be performed by at least one processor (e.g., the processor illustrated in FIG. 14) included in a computing system. In this regard, the computing system may include at least one of the navigation device, the mobile terminal, and the server. For convenience of description, FIG. 10 is described based on an example in which the method is performed by the navigation device illustrated in FIG. 1. Furthermore, in this embodiment, the method is described under assuming that a location of the destination and an appointment time are stored in the navigation device.

Referring to FIG. 10, the navigation device may detect that the vehicle has been parked in S1010. According to an embodiment, the navigation device may receive a message related to a vehicle's engine stop from a vehicle monitoring server (not illustrated in the drawing) communicating with the vehicle or a communication device mounted on the vehicle. When the message related to the vehicle's engine stop has been received, the navigation device may determine that the vehicle has been parked.

Subsequently, the navigation device may measure the current location and identify a preset destination in S1020 and S1030. In this regard, the destination may be an indoor location or an outdoor location.

Next, the navigation device may generate a travel route from the current location to the destination, and may display a navigation screen including the travel route in S1040. Furthermore, the navigation device may calculate a remaining time until the appointment time in S1050.

Next, the navigation device may determine an animation to be outputted based on the remaining time until the appointment time and a distance to the destination, and may play and output the determined animation on the navigation screen in S1060. The animation may be generated based on a GIF image, a flash image, a video, etc.

According to some embodiments, the navigation device may apply a third weight to the remaining time, and may apply a fourth weight to the distance to the destination, and then sum the weighted remaining time and distance to calculate an urging index. The navigation device may determine a first animation changing at a first speed as an output target animation when the urging index is included in a first range corresponding to a slow movement. The navigation device may determine a second animation changing at a second speed faster than the first speed as the output target animation when the urging index is included in a second range corresponding to a rapid movement. The determined output target animation may be played in relation with the travel route.

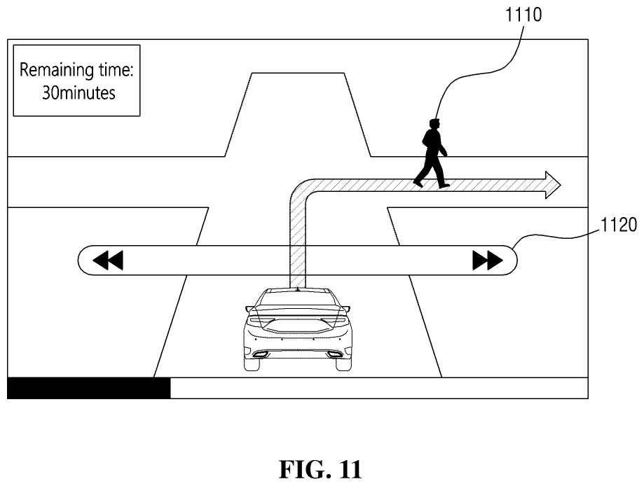

FIG. 11 is a diagram for illustrating a navigation screen including the first animation according to an embodiment of the present disclosure.

Referring to FIG. 11, when the urging index is included in the first range related to the slow movement, the navigation device may display the navigation screen including the first animation that requests general movement and changes at the first speed. As illustrated in FIG. 11, the navigation screen may display the remaining time until the appointment time, and may display an animation in which a character 1110 moves at a walking speed as the first speed.

Furthermore, the travel route may be simulated and the travel route may be rewound, in response to the user's input. For example, when the user input of swiping in a first direction (e.g., right direction) on a forward or reverse menu 1120 has been received, a simulation animation in which the travel route from the current location to the destination is played based on the swiping speed and a distance by which the menu is swiped may be displayed. The simulation animation to which the map image has been changed may be displayed, based on the user's average moving speed and a location of the user being moving. The playback speed of the simulation animation may be determined based on the swiping speed (e.g., a touch drag speed in the first direction). Furthermore, based on a distance by which the menu is swiped, a specific point in the travel route from the current location to the destination may be determined, and a portion of the travel route from the current location to the determined point may be simulated.

In an example, when the user input of swiping in a second direction (e.g., a left direction) on the forward or reverse menu 1120 has been received, a past travel route along which a travel route from a start location of the navigation service to the current location is played may be displayed, based on the swiping speed (e.g., the touch drag speed in the second direction) and the distance by which the menu is swiped. For example, based on the distance by which the menu is swiped, a past location from which the animation starts to be played may be determined, and the travel route from the current location to the determined past location may be displayed in a reverse chronological order. The playback speed may be determined and based on the swiping speed.

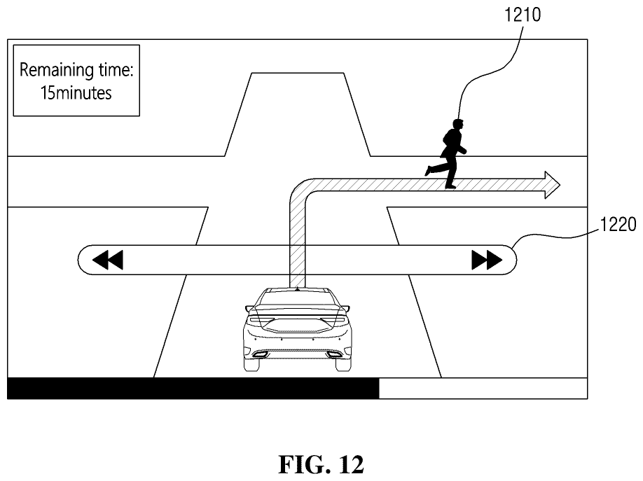

FIG. 12 is a diagram for illustrating a navigation screen including a second animation according to an embodiment of the present disclosure.

Referring to FIG. 12, when the urging index is included in the second range requiring the rapid movement, the navigation device may display the navigation screen including the second animation requiring the rapid movement and changing at the second speed. As illustrated in FIG. 12, the navigation screen may display the remaining time until the appointment time, and may display an animation in which the character 1210 moves at a running speed as the second speed. Furthermore, based on the user input of swiping on the forward or reverse menu 1120, the travel route may be simulated, and the travel route to a current point may be played in a reverse chronological order.

In an example, in a state where the navigation device is mounted on the vehicle, when the vehicle has been parked, the mobile terminal may display the navigation screen instead of the navigation device.

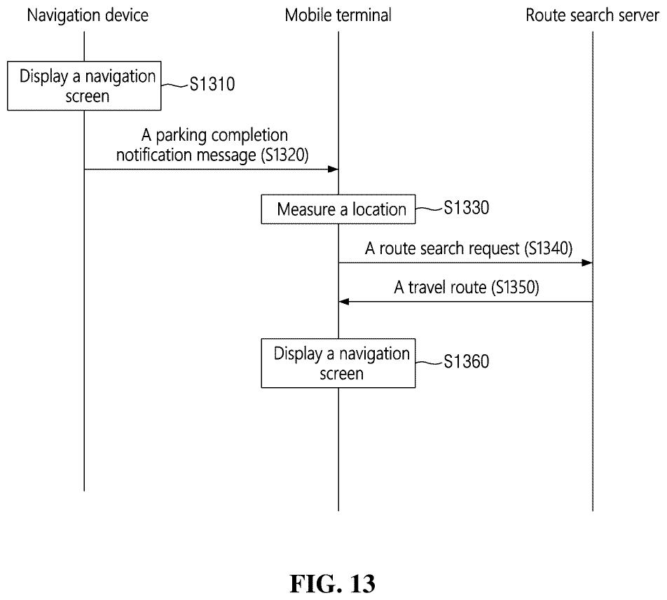

FIG. 13 is a signal processing diagram for illustrating a method in which a navigation device and a mobile terminal cooperate with each other to display a navigation screen according to still an embodiment of the present disclosure.

Referring to FIG. 13, the navigation device may display a navigation screen in S1310.

Subsequently, when the vehicle has been parked and the vehicle engine is turned off, the navigation device may transmit a parking completion notification message to the mobile terminal in S1320. In this regard, the mobile terminal may be a computing device capable of mobile communication, such as a smartphone. According to an embodiment, when the vehicle engine has been turned off, the mobile terminal may receive a destination location from the navigation device.

Next, the mobile terminal measures the current location, and may transmit a route search request including the measured location and the destination to the route search server in S1340. In this case, the route search server may search for a travel route based on the current location of the mobile terminal, the destination location, etc., and transmit the searched travel route to the mobile terminal in S1350. In this regard, the travel route may be a route along which the user will move on foot. As the vehicle engine has been turned off, it is determined that the user will move on foot. Thus, the mobile terminal may transmit a route search request in which a travel means is foot to the route search server, and may search for a travel route along which the user will move on foot and transmit the searched travel route to the mobile terminal.

Next, the mobile terminal may display a navigation screen where the travel route is visualized on a map image in S1360. The mobile terminal may measure the current location periodically or in real time, and update the map image displayed on the navigation screen based on the measured current location.

As described above, when it is determined that the camera angle-related event has occurred based on the current location, the mobile terminal may change the camera angle and output the navigation screen including the event-related information.

According to this embodiment, the navigation service may be provided on the navigation device in the vehicle. The navigation service may be provided using the mobile terminal after the vehicle engine stops. For example, the user may receive a driving route along which the vehicle may travel using the navigation device, and may receive a travel route along which the user may move on foot using the mobile terminal after the vehicle has been parked.

In an example, the embodiments as described above may be used in a navigation simulation. For example, a movement simulation based on a digital twin may be performed. In this case, the current location may be measured based on a virtual object. As the virtual object moves, the location may be updated. When the updated location is included in the location range that causes the camera angle change, the camera angle in the simulation may be changed, and the map image may be displayed at the changed camera angle. Furthermore, information related to the event may be displayed on the simulation screen.

FIG. 14 is a hardware configuration view of an exemplary computing system 1000 according to some embodiments of the present disclosure. The computing system 1000 may include at least one processor 1100, a bus 1600, a communication interface 1200, a memory 1400, which loads a computer program 1500 to be executed by the processor 1100, and a storage 1300, which stores the computer program 1500.

A computing system 1000 of FIG. 14 may be an example of a hardware structure of the computing system that constitutes the navigation system as described with reference to FIG. 1. For example, the computing system 1000 of FIG. 14 may be an example of the hardware structure of at least one of the navigation device, the route search server, and the mobile terminal.

The processor 1100 may control the overall operations of the components of the computing system 100. The processor 1100 may perform operations related to at least one application or program to execute operations/methods according to various embodiments of the present disclosure. The memory 1400 may store various data, commands, and/or information. The memory 1400 may load the computer program 1500 from the storage 1300 to execute the operations/methods according to various embodiments of the present disclosure. The storage 1300 may non-transitorily store at least one computer program 1500.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure.

According to an embodiment, a computer program 1500 may include instructions for displaying a navigation screen related to a first camera angle, determining whether an event related to angle change has occurred based on a measured location, changing a camera angle of the navigation screen from the first camera angle to a second camera angle, based on determination that the event related to the angle change has occurred, and displaying information related to the event.

Furthermore, the computer program 1500 may include instructions for determining whether a measured location is included in a location range related to a parking lot, acquiring parking lot information including an available parking space, upon determination that the measured location is included in the location range related to the parking lot, and displaying a navigation screen including a number of currently available parking spaces in each parking zone, and a moving direction to each parking zone, based on the acquired parking lot information, wherein one vehicle corresponds to one parking space.

In some embodiments, the computer program 1500 may include instructions for calculating a remaining time until an appointment time, determining an animation to be outputted, based on at least one of the calculated remaining time and a distance to a destination, and displaying a navigation screen including the determined animation.

The methods according to the embodiments of the present disclosure described above may be performed by executing a computer program implemented using a computer-readable code. The computer program may be transmitted from a first computing device to a second computing device via a network such as the Internet and installed on the second computing device, and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A method for providing a navigation service, the method being performed by a computing system, the method comprising:
displaying a navigation screen related to a first camera angle;
determining whether an event related to an angle change has occurred based on a measured location;
changing a camera angle of the navigation screen from the first camera angle to a second camera angle based on determination that the event related to the angle change has occurred; and
displaying information related to the event.

2. The method of claim 1, wherein the determining whether the event related to the angle change has occurred includes determining that the event has occurred when the measured location is included in a location range related to a parking lot, and
wherein the displaying the information related to the event includes displaying information related to the parking lot.

3. The method of claim 2, wherein the information related to the parking lot includes a parking lot drawing, and
wherein at the second camera angle, the parking lot drawing is displayed in a plan view on the navigation screen.

4. The method of claim 2, wherein the information related to the parking lot includes a parking lot drawing, and
wherein in the parking lot drawing, an available parking space is visualized using a first graphic element.

5. The method of claim 4, wherein in the parking lot drawing, a parking space for a driver requiring a social consideration is visualized using a second graphic element.

6. The method of claim 1, further comprising, after the displaying the information related to the event, changing the camera angle of the navigation screen to the first camera angle after a predetermined time duration has elapsed.

7. The method of claim 1, wherein the determining whether the event related to the angle change has occurred includes determining that the event has occurred when the measured location is included in a location range related to an elevator, and
wherein the changing the camera angle of the navigation screen includes zooming out the first camera angle to change the camera angle of the navigation screen to the second camera angle.

8. The method of claim 7, wherein the displaying the information related to the event includes displaying a floor where a user is located or an information on the floor.

9. The method of claim 7, wherein the displaying the information related to the event includes:
identifying a floor where a destination is located; and
displaying information including the floor or a travel route to the destination.

10. The method of claim 1, wherein the determining whether the event related to the angle change has occurred includes determining that the event has occurred when the measured location is included in a location range related to an access road, and
wherein the displaying the information related to the event includes displaying a guidance line related to the access road.

11. A method for providing a navigation service, the method being performed by a computing system, the method comprising:
determining whether a measured location is included in a location range related to a parking lot;
acquiring a parking lot information including an available parking space upon determination that the measured location is included in the location range related to the parking lot; and
displaying a navigation screen including a number of currently available parking spaces in each parking zone and a moving direction to each parking zone based on the parking lot information, wherein one vehicle corresponds to one parking space.

12. The method of claim 11, wherein the displaying the navigation screen includes displaying the navigation screen in which a first graphic element indicating the moving direction to the each parking zone and a second graphic element indicating the number of currently available parking spaces are displayed in a related manner to each other.

13. The method of claim 11, wherein the displaying the navigation screen includes determining a recommended parking zone based on the parking lot information and displaying the navigation screen in which a travel route to the recommended parking zone is visualized using a third graphic element.

14. The method of claim 13, wherein the determining the recommended parking zone includes determining the recommended parking zone based on the number of currently available parking spaces in the each parking zone included in the parking lot information and the measured location.

15. A method for providing a navigation service, the method being performed by a computing system, the method comprising:
calculating a remaining time until an appointment time;
determining an animation to be outputted based on the remaining time or a distance to a destination; and
displaying a navigation screen including the animation.

16. The method of claim 15, wherein the determining the animation to be outputted includes:
calculating an urging index based on the remaining time or the distance to the destination;
when the urging index is included in a first range, determining a first animation changing at a first speed as the animation to be outputted; and
when the urging index is included in a second range, determining a second animation changing at a second speed as the animation to be outputted.

17. The method of claim 15, wherein the displaying the navigation screen includes:
generating a travel route from a measured location to the destination upon detection that a vehicle has been parked; and
displaying the navigation screen in which the generated travel route is displayed, and
wherein the animation to be outputted is played in relation with the travel route.

18. The method of claim 17, wherein the computing system includes a mobile terminal, and
wherein upon detecting that the vehicle has been parked, the mobile terminal displays the navigation screen.

19. The method of claim 18, wherein the computing system includes a navigation device, and
wherein when the mobile terminal receives a message related to a vehicle engine stop from the navigation device, the mobile terminal determines that the vehicle has been parked and outputs the navigation screen.

20. The method of claim 15, wherein the navigation screen is capable of a simulation, and
wherein the method further comprises:
receiving a user input of swiping on the screen in a first direction or a second direction; and
based on the user input, playing the travel route at a predetermined speed or rewinding the travel route at the predetermined speed.
